(19) United States
(12) Patent Application Publication
(10) Pub. No.: US 2013/0204914 A1
(43) Pub. Date: Aug. 8, 2013

(54) PATIENT IDENTIFICATION BASED ON IMMUTABLE CHARACTERISTICS

(71) Applicants: Steven S. Behram, Potomac, MD (US); Nancy G. Behram, Potomac, MD (US); Sammy W. Joseph, Derwood, MD (US)

(72) Inventors: Steven S. Behram, Potomac, MD (US); Nancy G. Behram, Potomac, MD (US); Sammy W. Joseph, Derwood, MD (US)

(73) Assignee: Medical Informatics, LLC, Rockville, MD (US)

(21) Appl. No.: 13/367,166

(22) Filed: Feb. 6, 2012

(51) Int. Cl. G06F 7/00

(52) U.S. Cl. 708/200

(57) ABSTRACT

Techniques are described herein that are capable of identifying patients based on immutable characteristics. For instance, each patient identifier is based on immutable characteristics of the patient who is to be identified by that patient identifier. Examples of an immutable characteristic of a patient include but are not limited to the patient's first name, the patient's last name, the patient's birth date, the patient's birth city, the patient's birth state, the patient's birth country, the patient's mother's maiden name, the patient's gender, etc. For instance, portions of a patient identifier that identifies a patient may be based on respective subsets of immutable characteristics of the patient. Logical operations may be performed with respect to the respective portions of the patient identifier to determine a checksum identifier to facilitate detection of an error with respect to reproduction (e.g., scanning, manually typing, etc.) of the patient identifier.

### BACKGROUND

1. Field of the Invention

The invention generally relates to generating patient identifiers to identify patients.

2. Background

Patients traditionally are identified arbitrarily by non-standardized medical record numbers or identifiers that are assigned to them by various healthcare providers and/or medical institutions. Thus, a single individual may be identified in a variety of different ways and may have multiple medical record numbers. The existence of multiple medical record numbers for a single individual may have undesirable consequences. For example, exchange of information between the various providers and/or institutions that assign the numbers may be hindered. The probability of a medical error occurring may be increased. The probability of medical redundancy (e.g., duplicative testing of the same individual) may be increased, and so on.

Moreover, conventional techniques for identifying patients may negatively impact the usefulness of methods that are commonly used for identifying medical records. For example, local identifiers are often assigned to patients. Such assignment of local identifiers may cause difficulty in combining (e.g., collating) records from different providers and/or institutions. This issue is not resolved by use of electronic medical records (EMRs) or electronic health records (EHRs) because providers and institutions often use local rules and bridges to identify patients locally. Alternatively, fixed identifiers may be assigned by a central authority. However, this practice may jeopardize privacy of the records because the identifiers are known and stored in a central repository. Utilization of ancillary data fields (e.g., Social Security numbers) can expose other sensitive patient information, or result in delayed care or errors when such numbers are not unique or not immediately available at the time of service.

### SUMMARY

Various approaches are described herein for, among other things, identifying patients based on immutable characteristics. For instance, each patient identifier is based on immutable characteristics of the patient who is to be identified by that patient identifier. Examples of an immutable characteristic of a patient include but are not limited to the patient's first name, the patient's last name, the patient's birth date, the patient's birth city, the patient's birth state, the patient's birth country, the patient's mother's maiden name, the patient's gender, etc.

An example method is described in which responses are received in response to inquiries regarding immutable characteristics of a patient. The responses specify the immutable characteristics of the patient. Character strings are determined Each character string is based on a respective subset of the responses. The character strings are concatenated to provide a patient identifier that identifies the patient.

Another example method is described. In accordance with this method, responses are received in response to inquiries regarding immutable characteristics of a patient. The responses specify the immutable characteristics of the patient. Subsets of the responses are processed in accordance with respective predefined algorithms to determine a non-random, repeatable patient identifier that identifies the patient.

An example system is described that includes a string determination module and a string concatenation module. The string determination module is configured to determine character strings. Each character string is based on a respective subset of responses to queries regarding immutable characteristics of a patient. The responses specify the immutable characteristics of the patient. The string concatenation module is configured to concatenate the character strings to provide a patient identifier that identifies the patient.

Another example system is described that includes a processing module. The processing module is configured to process subsets of responses to inquiries regarding immutable characteristics of a patient in accordance with respective predefined algorithms to determine a non-random, repeatable patient identifier that identifies the patient. The responses specify the immutable characteristics of the patient.

An example computer program product is described that includes a computer-readable medium having computer program logic recorded thereon for providing a patient identifier that identifies a patient. The computer program product includes first and second program logic modules. The first program logic module is for enabling the processor-based system to determine character strings. Each character string is based on a respective subset of responses to queries regarding immutable characteristics of the patient. The responses specify the immutable characteristics of the patient. The second program logic module is for enabling the processor-based system to concatenate the character strings to provide the patient identifier that identifies the patient.

Another example computer program product is described that includes a computer-readable medium having computer program logic recorded thereon for providing a non-random, repeatable patient identifier that identifies a patient. The computer program product includes a program logic module for enabling the processor-based system to process subsets of responses to inquiries regarding immutable characteristics of the patient in accordance with respective predefined algorithms to determine the non-random, repeatable patient identifier that identifies the patient. The responses specify the immutable characteristics of the patient.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example identification system in accordance with an embodiment.

FIGS. 2, 6-8, and 11-12 depict flowcharts of example methods for generating a patient identifier to identify a patient in accordance with embodiments.

FIGS. 3, 10, and 14 are block diagrams of example implementations of a patient ID server system shown in FIG. 1 in accordance with embodiments.

FIGS. 4 and 13 depict flowcharts of example methods for generating a checksum identifier in accordance with embodiments.

FIG. 5 is a block diagram of an example implementation of a checksum module shown in FIG. 3 in accordance with an embodiment.

FIGS. 9A-9B depict respective portions of a flowchart of another example method for generating a patient identifier to identify a patient in accordance with an embodiment.

FIG. 15 depicts an example computer in which embodiments may be implemented.

FIG. 16 depicts an example questionnaire that includes a plurality of inquiries regarding immutable characteristics of a patient in accordance with an embodiment.

FIG. 17 depicts an example health security card that includes a patient identifier in accordance with an embodiment.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments

Example embodiments described herein are capable of identifying patients based on immutable characteristics. For instance, each patient identifier is based on immutable characteristics of the patient who is to be identified by that patient identifier. Examples of an immutable characteristic of a patient include but are not limited to the patient's first name, the patient's last name, the patient's birth date, the patient's birth city, the patient's birth state, the patient's birth country, the patient's mother's maiden name, the patient's gender, etc.

In some example embodiments, a multi-character checksum identifier is associated with a patient identifier to facilitate detection of an error with respect to reproduction (e.g., scanning, manually typing, etc.) of the patient identifier. For instance, logical operations may be performed with respect to respective subsets of the characters that are included in the patient identifier to determine the checksum identifier. The checksum identifier may include fewer characters than the patient identifier. For instance, the number of characters that are included in the checksum identifier may be the same as the number of subsets of the characters that are included in the patient identifier.

Example techniques described herein have a variety of benefits as compared to conventional techniques for generating patient identifiers. For instance, some example techniques may improve the exchange of information among providers and institutions, reduce the probability of medical errors occurring, reduce medical redundancy, and/or reduce (e.g., resolve) issues traditionally associated with identifying medical records. Moreover, the example techniques described herein need not be stored in a central repository. Furthermore, the example techniques may be capable of providing a unique patient identifier for each patient.

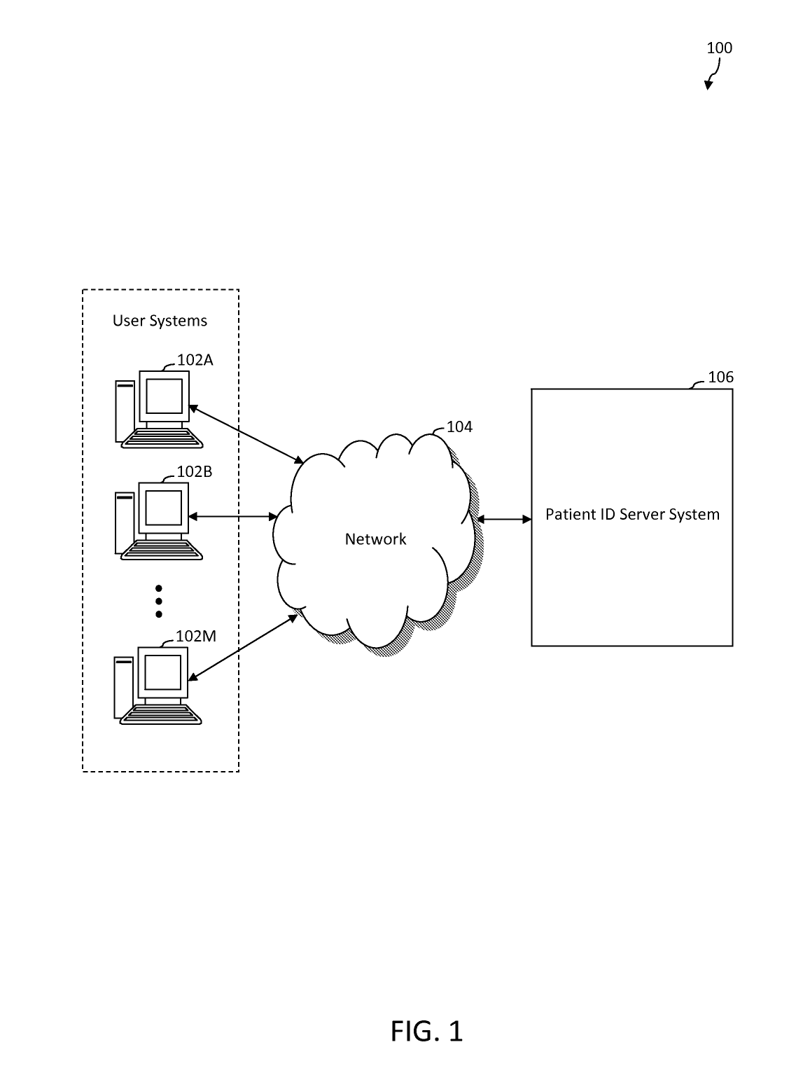

FIG. 1 is a block diagram of an example identification system 100 in accordance with an embodiment. Generally speaking, identification system 100 operates to generate patient identifiers for identifying patients. As shown in FIG. 1, identification system 100 includes a plurality of user systems 102A-102M, a network 104, and a patient identification (ID) server system 106. Communication among user systems 102A-102M and patient ID server system 106 is carried out over network 104 using well-known network communication protocols. Network 104 may be a wide-area network (e.g., the Internet), a local area network (LAN), another type of network, or a combination thereof

User systems 102A-102M are processing systems that are capable of communicating with patient ID server system 106. An example of a processing system is a system that includes at least one processor that is capable of manipulating data in accordance with a set of instructions. For instance, a processing system may be a computer, a personal digital assistant, etc. User systems 102A-102M are configured to provide requests (e.g., HTTP requests) to patient ID server system 106 for the purpose of initiating respective activities. Examples of an activity include but are not limited to generating a patient identifier, generating a health card that specifies a patient identifier, etc. For instance, a user may initiate a request using a client (e.g., a Web browser, Web crawler, non-Web-enabled client, etc.) deployed on a user system 102 that is owned by or otherwise accessible to the user for the purpose of initiating an activity.

In accordance with some example embodiments, user systems 102A-102M are capable of accessing Web sites hosted by patient ID server system 106, so that user systems 102A-102M may access information that is available via the Web sites. Such information may include documents (e.g., Web pages, images, video files, etc.), output of executables, or any other suitable type of information. The Web pages may be provided as hypertext markup language (HTML) documents and objects (e.g., files) that are linked therein, for example. In accordance with these embodiments, user systems 102A-102M may provide requests for initiating respective activities via the Web sites. The information that is available via the Web sites need not necessarily be stored on patient ID server system 106. For example, the information may be accessible via patient ID server system 106 but stored elsewhere (e.g., in a remote database or an external server).

Although user systems 102A-102M are depicted as desktop computers in FIG. 1, persons skilled in the relevant art(s) will appreciate that user systems 102A-102M may include any suitable system or device, including but not limited to a laptop computer, a tablet computer, a personal digital assistant, a cellular telephone, etc.

Patient ID server system 106 is a processing system that is capable of communicating with user systems 102A-102M. Patient ID server system 106 is configured to complete activities that are initiated by user systems 102A-102M. For example, patient ID server system 106 may complete the activities in response to receiving user-initiated requests regarding the activities from user systems 102A-102M. In accordance with this example, patient ID server system 106 may generate a patient identifier, generate a card that specifies a patient identifier, etc. in response to the user-initiated requests. Generating a card that specifies a patient identifier may include encoding a barcode and/or a magnetic strip of the card to include information regarding the patient identifier.

Patient ID server system 106 may also monitor health records of patients. A health record may be an electronic medical record (EMR), an electronic health record (EHR), a portable medical record (PMR), a paper record (PR), or any other suitable type of record that includes and/or identifies medical and/or health information regarding a patient. For example, patient ID server system 106 may automatically notify a patient upon determining that a change occurs with respect to a health record of the patient. In another example, patient ID server system 106 may automatically notify a patient upon determining that a health record of the patient is accessed.

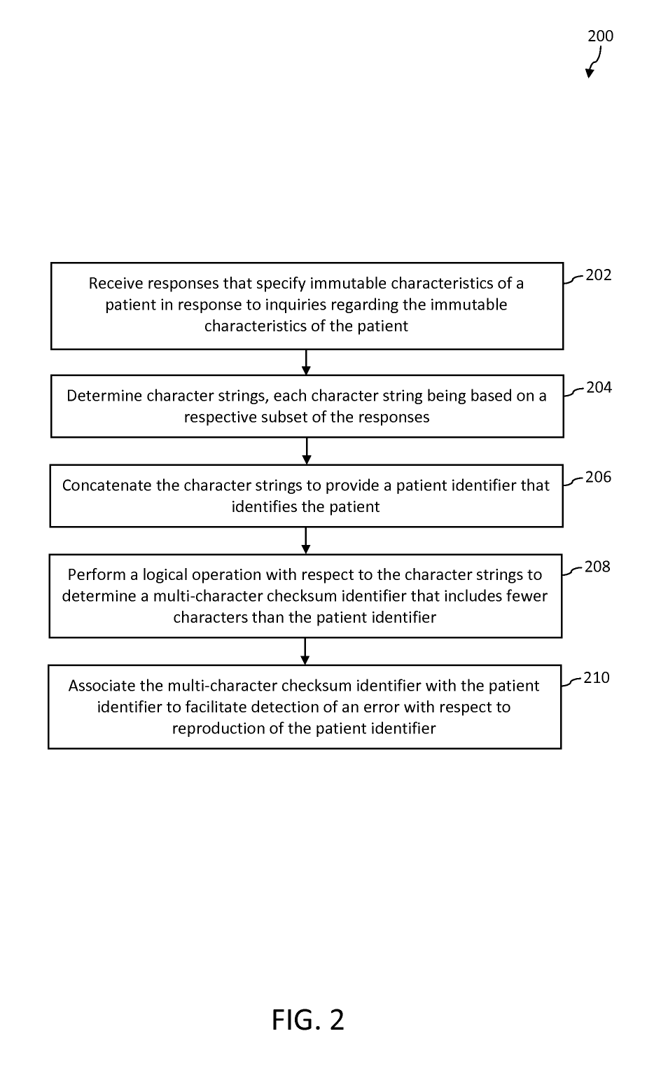

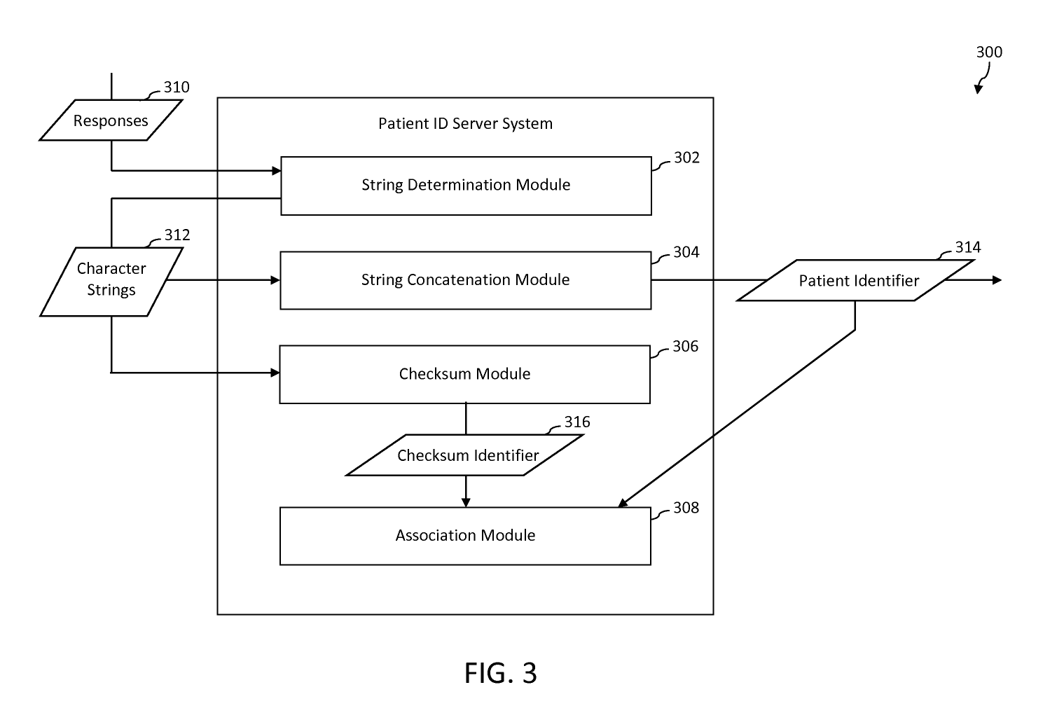

FIG. 2 depicts a flowchart 200 of an example method for generating a patient identifier to identify a patient in accordance with an embodiment. Flowchart 200 may be performed by patient ID server system 106 of identification system 100 shown in FIG. 1, for example. For illustrative purposes, flowchart 200 is described with respect to a patient ID server system 300 shown in FIG. 3, which is an example of a patient ID server system 106, according to an embodiment. As shown in FIG. 3, patient ID server system 300 includes a string determination module 302, a string concatenation module 304, a checksum module 306, and an association module 308. Further structural and operational embodiments will be apparent to persons skilled in the relevant art(s) based on the discussion regarding flowchart 200.

As shown in FIG. 2, the method of flowchart 200 begins at step 202. In step 202, responses are received that specify immutable characteristics of a patient in response to inquiries regarding the immutable characteristics of the patient. Examples of an immutable characteristic of a patient include but are not limited to the patient's first name at the time of the patient's birth, the patient's middle name at the time of the patient's birth, the patient's last name at the time of the patient's birth, the patient's date of birth, the city in which the patient was born (i.e., the patient's birth city), the state in which the patient was born (i.e., the patient's birth state), the country in which the patient was born (i.e., the patient's birth country), the maiden name of the patient's biological mother, and the patient's gender at the time of the patient's birth (e.g., as designated on the patient's birth certificate). It will be recognized that the responses may include abbreviations that represent the immutable characteristics (e.g., a two-character postal abbreviation that represents a birth state or birth country of the patient). In an example implementation, string determination module 302 receives responses 310 that specify the immutable characteristics of the patient.

In an example embodiment, the responses are received from the patient in response to inquiries that are presented to the patient. In another example embodiment, the responses are received in response to execution of instruction(s) that are configured to retrieve the responses from a store (e.g., a database). In accordance with this embodiment, an inquiry may be a call to a subroutine, for example, that is configured to retrieve a response.

At step 204, character strings are determined Each character string is based on a respective subset of the responses. A character string includes a plurality of characters. A character may be a number, a letter, a punctuation mark (e.g., a period, a question mark, an exclamation point, etc.), a mathematical operator (e.g., a plus sign, a minus sign, a multiplication sign, a division sign, etc.), or other suitable symbol (e.g., a dollar sign, a dash, a forward slash, a back slash, a percentage sign, etc.). For instance, a character may be an American Standard Code for Information (ASCII) character. In an example implementation, string determination module 302 determines character strings 312, such that each of the character strings 312 is based on a respective subset of the responses 310.

At step 206, the character strings are concatenated to provide a patient identifier that identifies the patient. For instance, the patient identifier may be a unique identifier, which uniquely identifies the patient. In an example implementation, string concatenation module 304 concatenates the character strings 312 to provide a patient identifier 314.

At step 208, a logical operation is performed with respect to the character strings to determine a multi-character checksum identifier that includes fewer characters than the patient identifier. A multi-character checksum identifier is a checksum identifier that includes more than one character. In an example implementation, checksum module 306 performs the logical operation with respect to character strings 312 to determine checksum identifier 316.

At step 210, the multi-character checksum identifier is associated with the patient identifier to facilitate detection of an error with respect to reproduction of the patient identifier. The reproduction of the patient identifier may be provided in response to manual data entry of the patient identifier, scanning of the patient identifier, or some other technique for reproducing the patient identifier. In an example implementation, association module 308 associates the checksum identifier 316 with the patient identifier 314 to facilitate detection of an error with respect to reproduction of the patient identifier 314.

In some example embodiments, one or more steps 202, 204, 206, 208, and/or 210 of flowchart 200 may not be performed. Moreover, steps in addition to or in lieu of steps 202, 204, 206, 208, and/or 210 may be performed.

It will be recognized that patient ID server system 300 may not include one or more of string determination module 302, string concatenation module 304, checksum module 306, and/or association module 308. Furthermore, patient ID server system 300 may include modules in addition to or in lieu of string determination module 302, string concatenation module 304, checksum module 306, and/or association module 308.

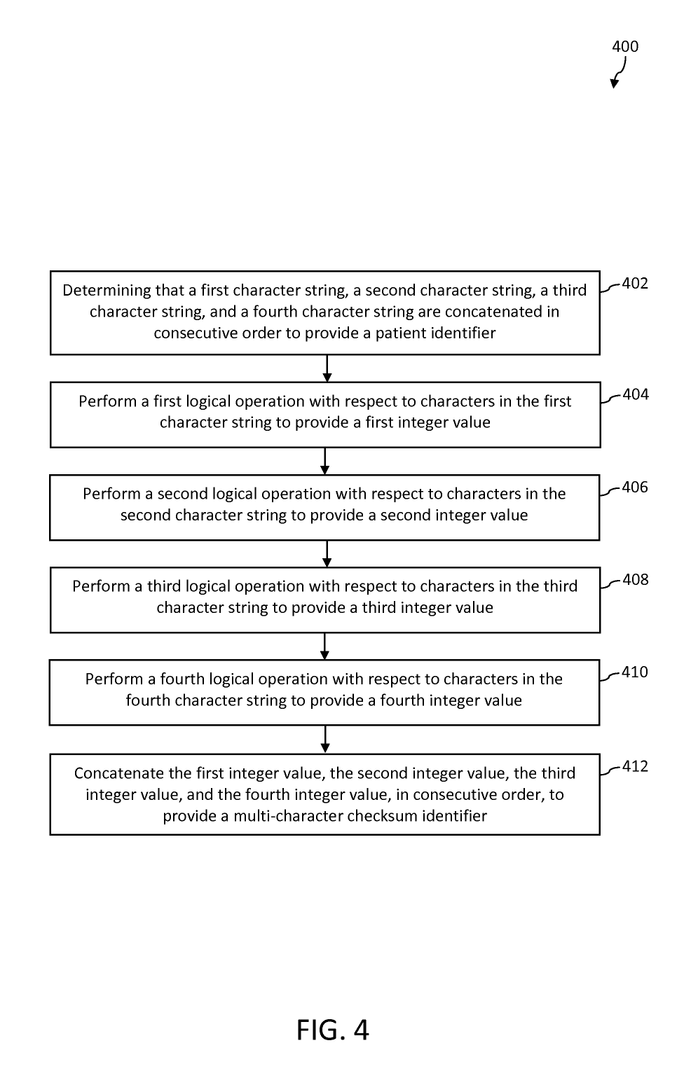

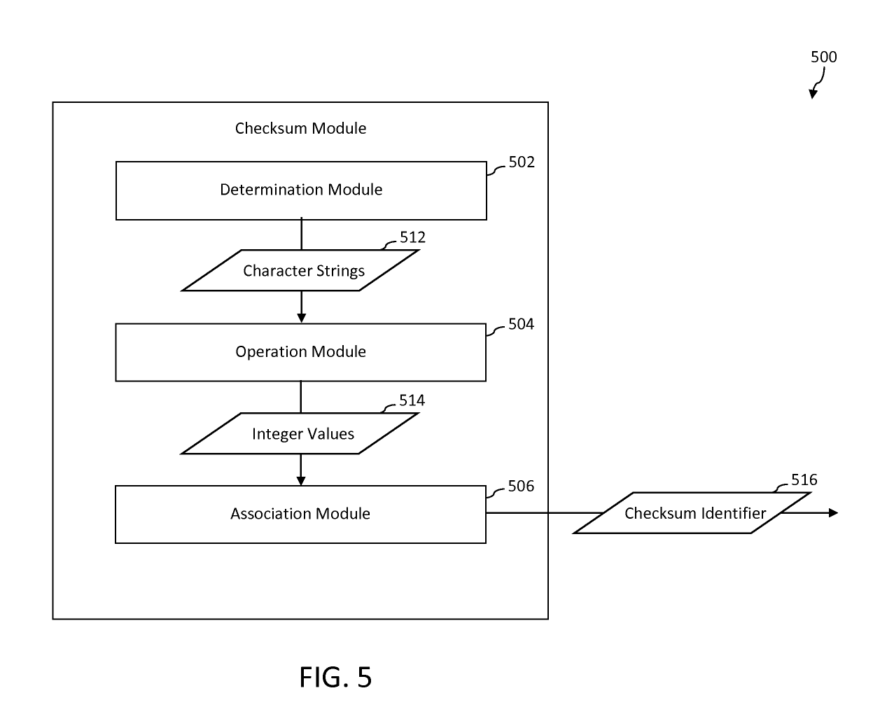

FIG. 4 depicts a flowchart 400 of an example method for generating a checksum identifier in accordance with an embodiment. Flowchart 400 may be performed by checksum module 306 of patient ID server system 300 shown in FIG. 3, for example. For illustrative purposes, flowchart 400 is described with respect to a checksum module 500 shown in FIG. 3, which is an example of a checksum module 306, according to an embodiment. As shown in FIG. 5, checksum module 500 includes a determination module 502, an operation module 504, and a character concatenation module 506. Further structural and operational embodiments will be apparent to persons skilled in the relevant art(s) based on the discussion regarding flowchart 400.

As shown in FIG. 4, the method of flowchart 400 begins at step 402. In step 402, a determination is made that a first character string, a second character string, a third character string, and a fourth character string are concatenated in consecutive order to provide a patient identifier. In an example implementation, determination module 502 determines that the first, second, third, and fourth character strings are concatenated in consecutive order to provide the patient identifier. For instance, determination module 502 may provide character strings 512, which includes the first, second, third, and fourth character strings, to operation module 504 for further processing.

At step 404, a first logical operation is performed with respect to characters in the first character string to provide a first integer value. In an example implementation, operation module 504 performs the first logical operation with respect to the characters in the first character string to provide the first integer.

At step 406, a second logical operation is performed with respect to characters in the second character string to provide a second integer value. In an example implementation, operation module 504 performs the second logical operation with respect to the characters in the second character string to provide the second integer value.

At step 408, a third logical operation is performed with respect to characters in the third character string to provide a third integer value. In an example implementation, operation module 504 performs the third logical operation with respect to the characters in the third character string to provide the third integer value.

At step 410, a fourth logical operation is performed with respect to characters in the fourth character string to provide a fourth integer value. In an example implementation, operation module 504 performs the fourth logical operation with respect to the characters in the fourth character string to provide the fourth integer value. For instance, operation module 504 may provide integer values 514, which includes the first, second, third, and fourth integer values, to association module 506 for further processing.

At step 412, the first integer value, the second integer value, the third integer value, and the fourth integer value are concatenated, in consecutive order, to provide a multi-character checksum identifier. In an example implementation, character concatenation module 506 concatenates the first, second, third, and fourth integer values in consecutive order to provide checksum identifier 516.

In some example embodiments, one or more steps 402, 404, 406, 408, 410, and/or 412 of flowchart 400 may not be performed. Moreover, steps in addition to or in lieu of steps 402, 404, 406, 408, 410, and/or 412 may be performed.

It will be recognized that checksum module 500 may not include one or more of determination module 502, operation module 504, and/or character concatenation module 506. Furthermore, checksum module 500 may include modules in addition to or in lieu of determination module 502, operation module 504, and/or character concatenation module 506.

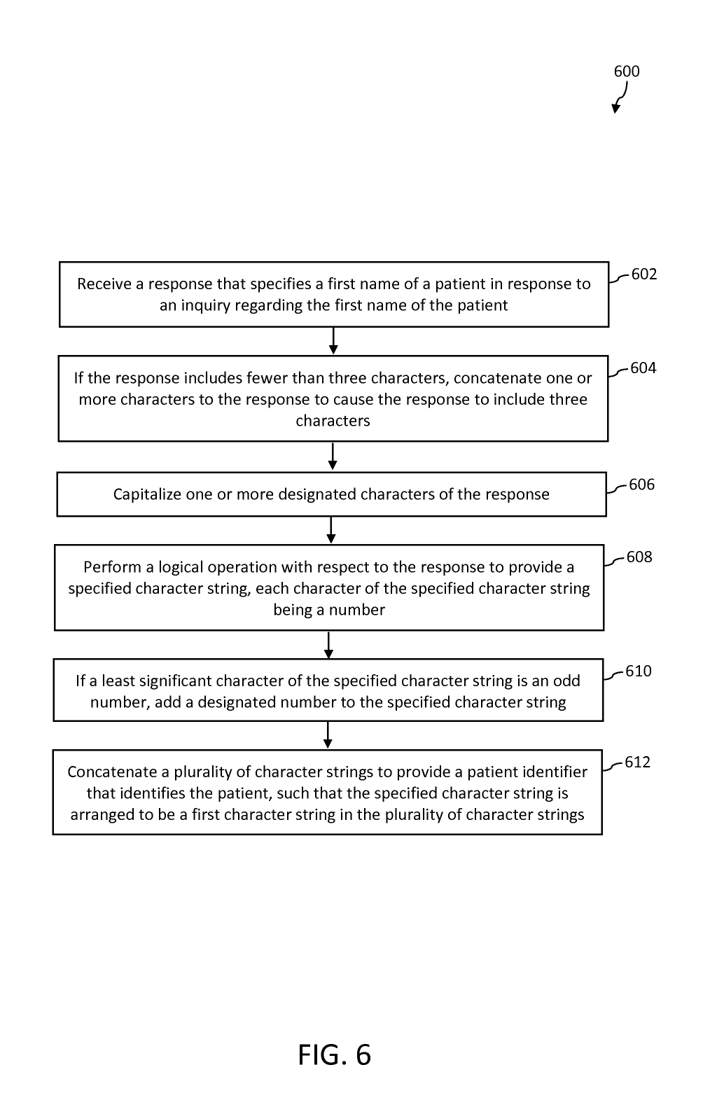

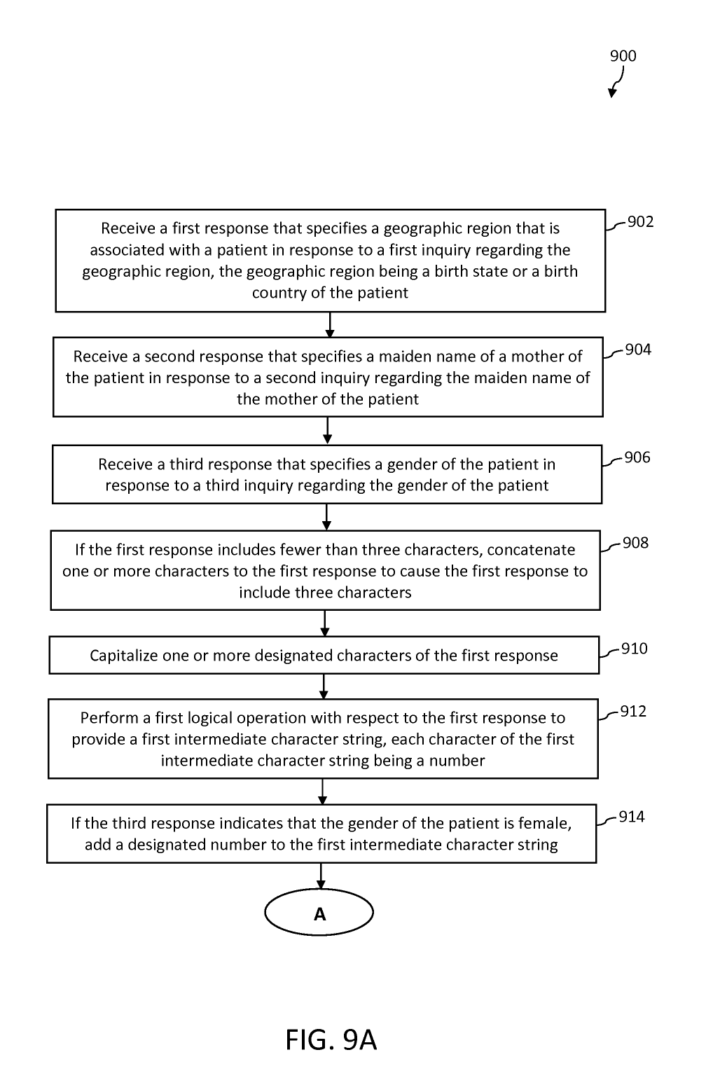

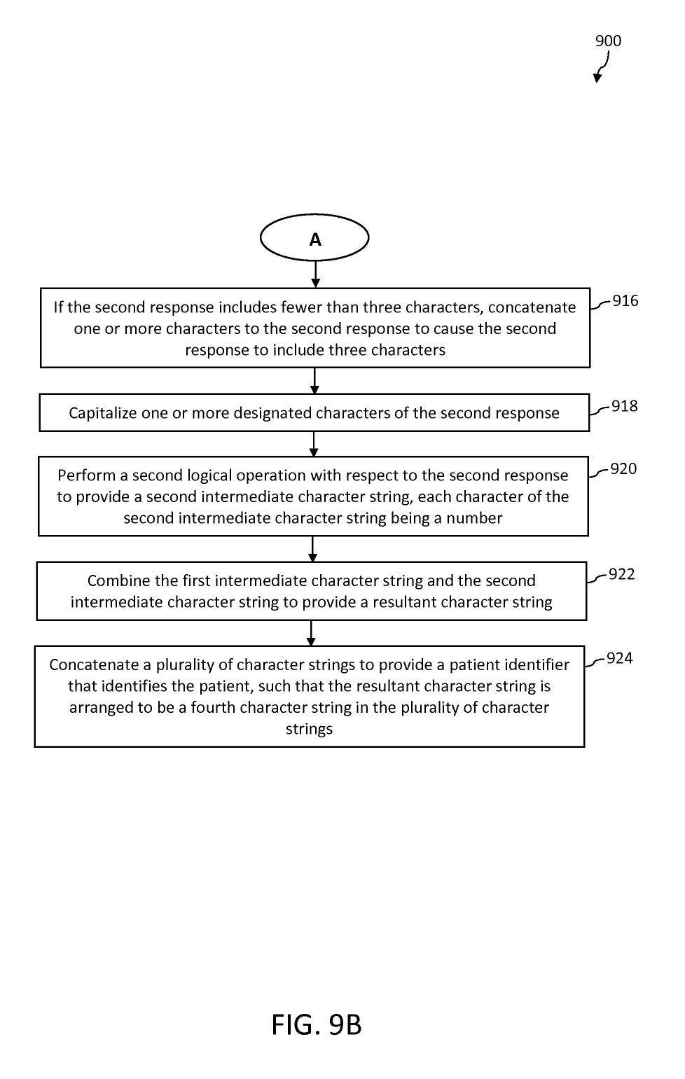

FIGS. 6-8 depict flowcharts 600, 700, and 800 of other example methods for generating a patient identifier to identify a patient in accordance with embodiments. FIGS. 9A-9B depict respective portions of a flowchart 900 of another example method for generating a patient identifier to identify a patient in accordance with an embodiment. Flowcharts 600, 700, 800, and 900 may be performed by patient ID server system 106 of identification system 100 shown in FIG. 1, for example. For illustrative purposes, flowcharts 600, 700, 800, and 900 are described with respect to a patient ID server system 1000 shown in FIG. 10, which is another example of a patient ID server system 106, according to an embodiment. As shown in FIG. 10, patient ID server system 1000 includes a string determination module 1002 and a checksum module 1004. String determination module 1002 includes a character concatenation module 1006, a capitalization module 1008, an operation module 1010, and a combination module 1012. Further structural and operational embodiments will be apparent to persons skilled in the relevant art(s) based on the discussion regarding flowcharts 600, 700, 800, and 900.

As shown in FIG. 6, the method of flowchart 600 begins at step 602. In step 602, a response is received that specifies a first name of a patient in response to an inquiry regarding the first name of the patient. In an example implementation, string determination module 102 receives the response that specifies the first name of the patient.

At step 604, if the response includes fewer than three characters, one or more characters are concatenated to the response to cause the response to include three characters. In an example implementation, character concatenation module 1006 concatenates character(s) to the response to cause the response to include three characters, if the response as received at step 602 includes fewer than three characters.

In an example embodiment, step 604 may be implemented in accordance with the following software code:

IF(LEN(FirstName)=0, “---”, IF(LEN(FirstName)=1, FirstName&“--”, IF(LEN(FirstName)=2, FirstName&“-”, FirstName)))

At step 606, one or more designated characters of the response are capitalized.

In an example implementation, capitalization module 1008 capitalizes designated character(s) of the response.

In an example embodiment, step 606 may be implemented in accordance with the following software code:

UPPER(MID(FirstName, 1, 1)) & UPPER(MID(FirstName, 2, 1) & UPPER(MID(FirstName, LEN(FirstName), 1)))

It may be desirable to determine whether one or more characters of the response are letters of the alphabet. In accordance with an example embodiment, such a determination may be made in accordance with the following software code:

IF(AND(CODE(MID(FirstName, 1, 1))>=65, CODE(MID(FirstName, 1, 1))<=65+26), MID(FirstName, 1, 1), “[”) & IF(AND(CODE(MID(FirstName, 2, 1))>=65, CODE(MID(FirstName, 2, 1))<=65+26), MID(FirstName, 2, 1), “[”) & IF(AND(CODE(MID(FirstName, 3, 1))>=65, CODE(MID(FirstName, 3, 1))<=65+26), MID(FirstName, 3, 1), “[”)

At step 608, a logical operation is performed with respect to the response to provide a specified character string. Each character of the specified character string is a number. In an example implementation, operation module 1010 performs the logical operation with respect to the response to provide the specified character string.

In an example embodiment, step 608 may be implemented in accordance with the following software code:

FirstNameString=((CODE(UPPER(MID(FirstName, 1, 1)))−65)*27̂)+((CODE(UPPER(MID(FirstName, 2, 1)))−65)*27̂1)+((CODE(UPPER(MID(FirstName, 3, 1)))−65)*27̂0)

At step 610, if a least significant character of the specified character string is an odd number, a designated number is added to the specified character string. In an example implementation, operation module 1010 adds the designated number to the specified character string if a least significant character of the specified character string is an odd number.

In an example embodiment, step 610 may be implemented in accordance with the following software code:

If FirstName is of odd length, then

FirstNameString=FirstNameString+18926

In an example embodiment, the specified character string may be provided in accordance with the following software code:

TEXT(FirstNameString, “00000”)

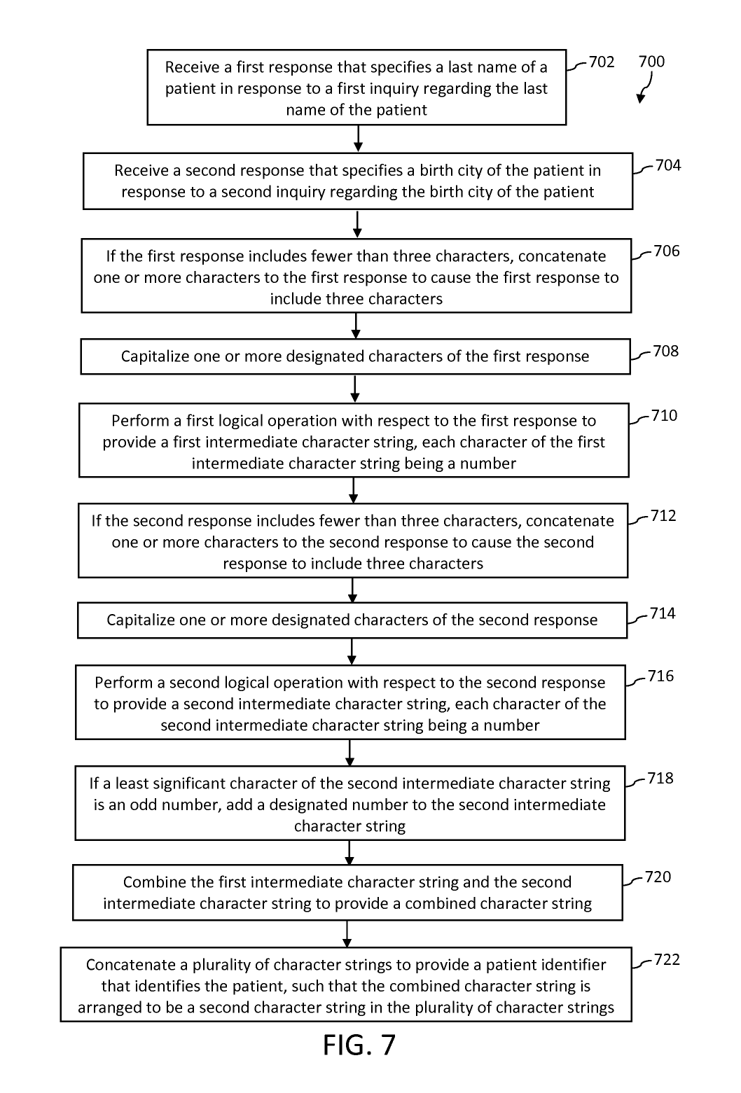

At step 612, a plurality of character strings is concatenated to provide a patient identifier that identifies the patient, such that the specified character string is arranged to be a first character string in the plurality of character strings. In an example implementation, string concatenation module 1004 concatenates the plurality of character strings to provide the patient identifier, such that the specified character string is arranged to be the first character string in the plurality of character strings. Combination module 1012 is described below with reference to flowcharts 700 and 900 of respective FIGS. 7 and 9.

In some example embodiments, one or more steps 602, 604, 606, 608, 610, and/or 612 of flowchart 600 may not be performed. Moreover, steps in addition to or in lieu of steps 602, 604, 606, 608, 610, and/or 612 may be performed.

As shown in FIG. 7, the method of flowchart 700 begins at step 702. In step 702, a first response is received that specifies a last name of a patient in response to a first inquiry regarding the last name of the patient. In an example implementation, string determination module 1002 receives the first response that specifies the last name of the patient.

At step 704, a second response is received that specifies a birth city of the patient in response to a second inquiry regarding the birth city of the patient. In an example implementation, string determination module 1002 receives the second response that specifies the birth city of the patient.

At step 706, if the first response includes fewer than three characters, one or more characters are concatenated to the first response to cause the first response to include three characters. In an example implementation, character concatenation module 1006 concatenates character(s) to the first response to cause the first response to include three characters if the first response as received at step 702 includes fewer than three characters.

In an example embodiment, step 706 may be implemented in accordance with the following software code:

IF(LEN(LASTNAME)=0,“---”, IF(LEN(LASTNAME)=1, LASTNAME& “--”, IF(LEN(LASTNAME)=2, LASTNAME&“-”, LASTNAME)))

At step 708, one or more designated characters of the first response are capitalized. In an example implementation, capitalization module 1008 capitalizes designated character(s) of the first response.

In an example embodiment, step 708 may be implemented in accordance with the following software code:

UPPER(MID(LastName, 1, 1)) & UPPER(MID(LastName, 2, 1))

It may be desirable to determine whether one or more characters of the first response are letters of the alphabet. In accordance with an example embodiment, such a determination may be made in accordance with the following software code:

IF(AND(CODE(MID(LastName, 1, 1))>=65, CODE(MID(LastName, 1, 1))<=65+26), MID(LastName, 1, 1), “[”) & IF(AND(CODE(MID(LastName, 2, 1))>=65, CODE(MID(LastName, 2, 1))<=65+26), MID(LastName, 2, 1), “[”)

At step 710, a first logical operation is performed with respect to the first response to provide a first intermediate character string. Each character of the first intermediate character string is a number. In an example implementation, operation module 1010 performs the first logical operation with respect to the first response to provide the first intermediate character string.

In an example embodiment, step 710 may be implemented in accordance with the following software code:

LastNameString=((CODE(UPPER(MID(LastName, 1, 1)))−65)*27̂1)+((CODE(UPPER(MID(LastName, 2, 1)))−65)*27̂0)

At step 712, if the second response includes fewer than three characters, one or more characters are concatenated to the second response to cause the second response to include three characters. In an example implementation, character concatenation module 1006 concatenates character(s) to the second response to cause the second response to include three characters if the second response as received at step 704 includes fewer than three characters.

In an example embodiment, step 712 may be implemented in accordance with the following software code:

IF(LEN(CityName)=0, “---”, IF(LEN(CityName)=1, CityName&“--”, IF(LEN(CityName)=2, CityName&“-”, CityName)))

At step 714, one or more designated characters of the second response are capitalized. In an example implementation, capitalization module 1008 capitalizes designated character(s) of the second response.

In an example embodiment, step 714 may be implemented in accordance with the following software code:

UPPER(MID(CityName, 1, 1))

It may be desirable to determine whether one or more characters of the second response are letters of the alphabet. In accordance with an example embodiment, such a determination may be made in accordance with the following software code:

IF(AND(CODE(MID(CityName, 1, 1))>=65, CODE(MID(CityName, 1, 1))<=65+26), MID(CityName, 1, 1), “[”)

At step 716, a second logical operation is performed with respect to the second response to provide a second intermediate character string. Each character of the second intermediate character string being a number. In an example implementation, operation module 1010 performs the second logical operation with respect to the second response to provide the second intermediate character string.

In an example embodiment, step 716 may be implemented in accordance with the following software code:

CityNameString=((CODE(UPPER(MID(CityName, 1, 1)))−65)*27̂0)

At step 718, if a least significant character of the second intermediate character string is an odd number, a designated number is added to the second intermediate character string. In an example implementation, operation module 1010 adds the designated number to the second intermediate character string if the least significant character of the second intermediate character string is an odd number.

In an example embodiment, step 718 may be implemented in accordance with the following software code:

If CityName is of odd length, then

CityNameString=CityNameString+27

At step 720, the first intermediate character string and the second intermediate character string are combined to provide a combined character string. In an example implementation, combination module 1012 combines the first and second intermediate character strings to provide the combined character string.

In an example embodiment, step 720 may be implemented in accordance with the following software code:

TEXT(LastNameString, “000”) & TEXT(CityNameString, “00”)

At step 722, a plurality of character strings is concatenated to provide a patient identifier that identifies the patient, such that the combined character string is arranged to be a second character string in the plurality of character strings. In an example implementation, string concatenation module 1004 concatenates the plurality of character strings, such that the combined character string is arranged to be the second character string in the plurality of character strings.

In some example embodiments, one or more steps 702, 704, 706, 708, 710, 712, 714, 716, 718, 720, and/or 722 of flowchart 700 may not be performed. Moreover, steps in addition to or in lieu of steps 702, 704, 706, 708, 710, 712, 714, 716, 718, 720, and/or 722 may be performed.

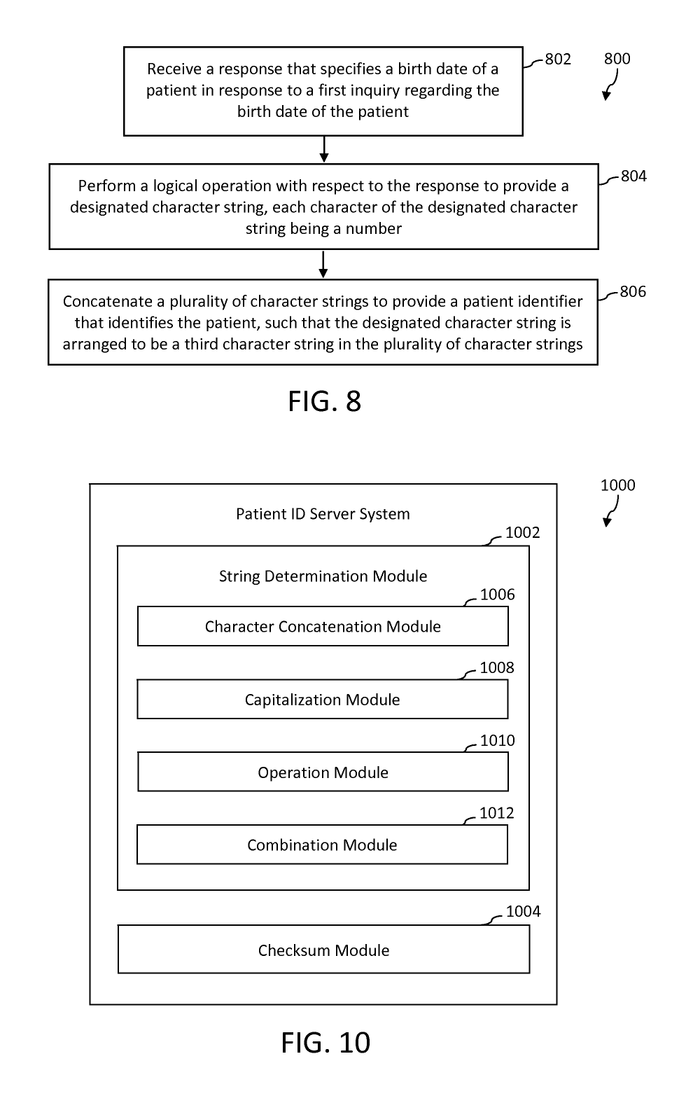

As shown in FIG. 8, the method of flowchart 800 begins at step 802. In step 802, a response is received that specifies a birth date of a patient in response to a first inquiry regarding the birth date of the patient. In an example implementation, string determination module 1002 receives the response that specifies the birth date of the patient.

At step 804, a logical operation is performed with respect to the response to provide a designated character string. Each character of the designated character string is a number. In an example implementation, operation module 1010 performs the logical operation with respect to the response to provide the designated character string.

In an example embodiment, step 804 may be implemented in accordance with the following software code:

DOBString=Datevalue(DOB)

In an example embodiment, the designated character string may be provided in accordance with the following software code:

Text(DOB String, “00”)

At step 806, a plurality of character strings is concatenated to provide a patient identifier that identifies the patient, such that the designated character string is arranged to be a third character string in the plurality of character strings. In an example implementation, checksum module 1004 concatenates the plurality of character strings to provide the patient identifier that identifies the patient, such that the designated character string is arranged to be the third character string in the plurality of character strings.

In some example embodiments, one or more steps 802, 804, and/or 806 of flowchart 800 may not be performed. Moreover, steps in addition to or in lieu of steps 802, 804, and/or 806 may be performed.

As shown in FIG. 9A, the method of flowchart 900 begins at step 902. In step 902, a first response is received that specifies a geographic region that is associated with a patient in response to a first inquiry regarding the geographic region. The geographic region is a birth state or a birth country of the patient. In an example implementation, string determination module 1002 receives the first response that specifies the geographic region that is associated with the patient.

At step 904, a second response is received that specifies a maiden name of a mother of the patient in response to a second inquiry regarding the maiden name of the mother of the patient. In an example implementation, string determination module 1002 receives the second response that specifies the maiden name of the patient's mother.

At step 906, a third response is received that specifies a gender of the patient in response to a third inquiry regarding the gender of the patient. In an example implementation, string determination module 1002 receives the third response that specifies the gender of the patient.

At step 908, if the first response includes fewer than three characters, one or more characters are concatenated to the first response to cause the first response to include three characters. In an example implementation, character concatenation module 1006 concatenates character(s) to the first response to cause the first response to include three characters if the first response as received at step 902 includes fewer than three characters.

In an example embodiment, step 908 may be implemented in accordance with the following software code:

IF(LEN(StateName)=0, “---”, IF(LEN(StateName)=1, StateName&“--”,

IF(LEN(StateName)=2, StateName&“-”, StateName)))

At step 910, one or more designated characters of the first response are capitalized. In an example implementation, capitalization module 1008 capitalizes designated character(s) of the first response.

In an example embodiment, step 910 may be implemented in accordance with the following software code:

UPPER(MID(StateName, 1, 1)) & UPPER(MID(StateName, 2, 1))

It may be desirable to determine whether one or more characters of the first response are letters of the alphabet. In accordance with an example embodiment, such a determination may be made in accordance with the following software code:

IF(AND(CODE(MID(StateName, 1, 1))>=65, CODE(MID(StateName, 1, 1))<=65+26), MID(StateName, 1, 1), “[”) &

IF(AND(CODE(MID(StateName, 2, 1))>=65, CODE(MID(StateName, 2, 1))<=65+26), MID(StateName, 2, 1), “[”)

At step 912, a first logical operation is performed with respect to the first response to provide a first intermediate character string. Each character of the first intermediate character string is a number. In an example implementation, operation module 1010 performs the first logical operation with respect to the first response to provide the first intermediate character string.

In an example embodiment, step 912 may be implemented in accordance with the following software code:

StateNameString=((CODE(UPPER(MID(StateName, 1, 1)))−65)*27̂0)

At step 914, if the third response indicates that the gender of the patient is female, a designated number is added to the first intermediate character string. In an example implementation, operation module 1010 adds the designated number to the first intermediate character string if the third response indicates that the gender of the patient is female. Upon completion of step 914, flow continues to step 916, which is shown in FIG. 9B.

In an example embodiment, step 914 may be implemented in accordance with the following software code:

If gender is female, then

StateNameString=StateNameString+27

At step 916, if the second response includes fewer than three characters, one or more characters are concatenated to the second response to cause the second response to include three characters. In an example implementation, character concatenation module 1006 concatenates character(s) to the second response to cause the second response to include three characters if the second response as received at step 904 includes fewer than three characters.

In an example embodiment, step 916 may be implemented in accordance with the following software code:

IF(LEN(MotherName)=0, “---”, IF(LEN(MotherName)=1, MotherName&“--”,

IF(LEN(MotherName) =2, MotherName & “-”, MotherName)))

At step 918, one or more designated characters of the second response are capitalized. In an example implementation, capitalization module 1008 capitalizes designated character(s) of the second response.

In an example embodiment, step 918 may be implemented in accordance with the following software code:

UPPER(MID(MotherName, 1, 1))

It may be desirable to determine whether one or more characters of the second response are letters of the alphabet. In accordance with an example embodiment, such a determination may be made in accordance with the following software code:

IF(AND(CODE(MID(MotherName, 1, 1))>=65, CODE(MID(MotherName, 1, 1))<=65+26), MID(MotherName, 1, 1), “[”)

At step 920, a second logical operation is performed with respect to the second response to provide a second intermediate character string. Each character of the second intermediate character string is a number. In an example implementation, operation module 1010 performs the second logical operation with respect to the second response to provide the second intermediate character string.

In an example embodiment, step 920 may be implemented in accordance with the following software code:

MotherNameString=((CODE(UPPER(MID(MotherName, 1, 1)))−65)*27̂0)

At step 922, the first intermediate character string and the second intermediate character string are combined to provide a resultant character string. In an example implementation, combination module 1012 combines the first and second intermediate character strings to provide the resultant character string.

In an example embodiment, step 922 may be implemented in accordance with the following software code:

TEXT(StateNameString, “00”) & TEXT(MotherNameString, “000”)

At step 924, a plurality of character strings is concatenated to provide a patient identifier that identifies the patient, such that the resultant character string is arranged to be a fourth character string in the plurality of character strings. In an example implementation, string concatenation module 1004 concatenates the plurality of character strings to provide the patient identifier, such that the resultant character string is arranged to be the fourth character string in the plurality of character strings.

In some example embodiments, one or more steps 902, 904, 906, 908, 910, 912, 914, 916, 918, 920, 922, and/or 924 of flowchart 900 may not be performed. Moreover, steps in addition to or in lieu of steps 902, 904, 906, 908, 910, 912, 914, 916, 918, 920, 922, and/or 924 may be performed.

It will be recognized that patient ID server system 1000 may not include one or more of string determination module 1002, checksum module 1004, character concatenation module 1006, capitalization module 1008, operation module 1010, and/or combination module 1012. Furthermore, patient ID server system 1000 may include modules in addition to or in lieu of string determination module 1002, checksum module 1004, character concatenation module 1006, capitalization module 1008, operation module 1010, and/or combination module 1012.

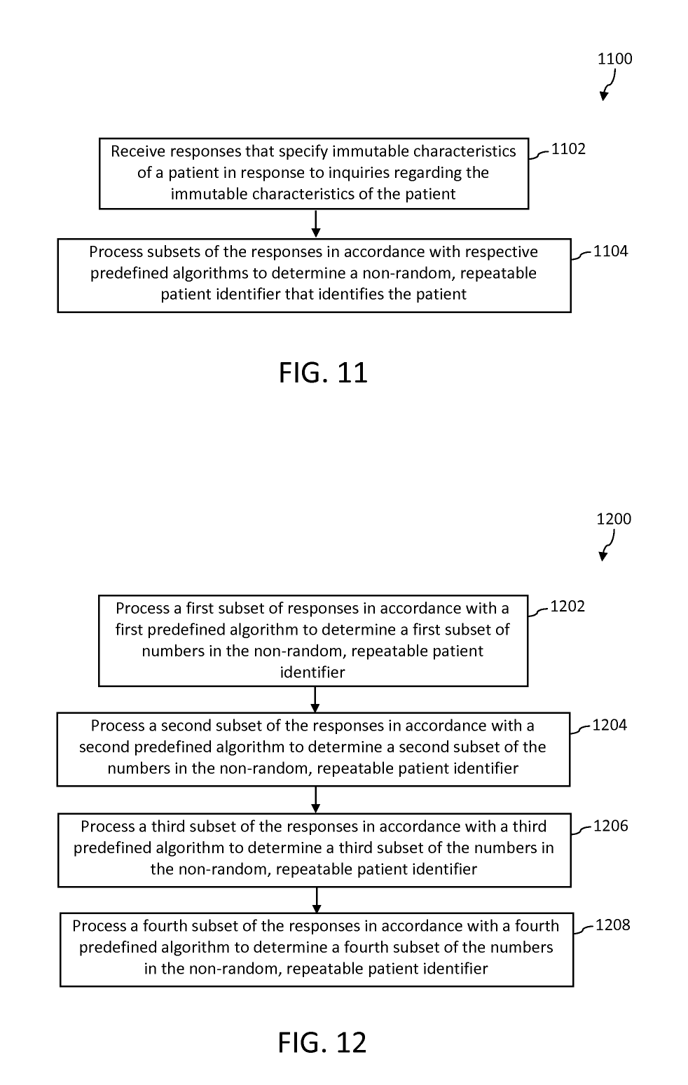

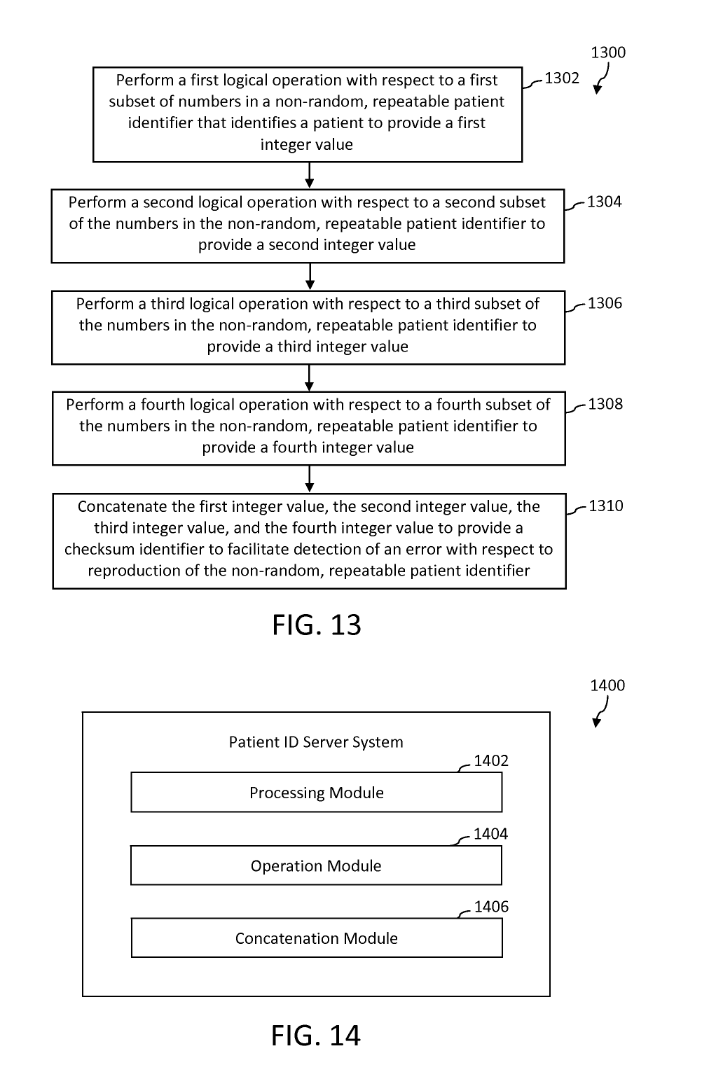

FIG. 11 depicts a flowchart 1100 of another example method for generating a patient identifier to identify a patient in accordance with an embodiment. FIG. 12 depicts a flowchart 1200 of an example implementation of step 1104 of flowchart 1100 in FIG. 11 in accordance with an embodiment. FIG. 13 depicts a flowchart 1300 of another example method for generating a checksum identifier in accordance with an embodiment. For illustrative purposes, flowcharts 1100, 1200, and 1300 are described with respect to a patient ID server system 1400 shown in FIG. 14, which is another example of a patient ID server system 106, according to an embodiment. As shown in FIG. 14, patient ID server system 1400 includes a processing module 1402, an operation module 1404, and a concatenation module 1406. Further structural and operational embodiments will be apparent to persons skilled in the relevant art(s) based on the discussion regarding flowcharts 1100, 1200, and 1300.

As shown in FIG. 11, the method of flowchart 1100 begins at step 1102. In step 1102, responses are received that specify immutable characteristics of a patient in response to inquiries regarding the immutable characteristics of the patient. In an example implementation, processing module 1402 receives the responses that specify the immutable characteristics of the patient.

At step 1104, subsets of the responses are processed in accordance with respective predefined algorithms to determine a non-random, repeatable patient identifier that identifies the patient. A non-random patient identifier is a patient identifier that is based on factors which are determinable (i.e., non-random), such as immutable characteristics of a patient. A repeatable patient identifier is a patient identifier that is obtainable upon successive iterations of predefined operation(s) (e.g., the predefined algorithms described with reference to step 1104). Accordingly, the patient identifier does not change with different iterations of the predefined operation(s). In an example implementation, processing module 1402 processes the subsets of the responses in accordance with the respective predefined algorithms to determine the non-random, repeatable patient identifier. Operation module 1406 and concatenation module 1406 are described below with reference to flowchart 1300 of FIG. 13.

As shown in FIG. 12, the method of flowchart 1200 begins at step 1202. In step 1202, a first subset of responses is processed in accordance with a first predefined algorithm to determine a first subset of numbers in the non-random, repeatable patient identifier. In an example implementation, processing module 1402 processes the first subset of the responses in accordance with the first predefined algorithm to determine the first subset of numbers.

At step 1204, a second subset of the responses is processed in accordance with a second predefined algorithm to determine a second subset of the numbers in the non-random, repeatable patient identifier. In an example implementation, processing module 1402 processes the second subset of the responses in accordance with the second predefined algorithm to determine the second subset of the numbers.

At step 1206, a third subset of the responses is processed in accordance with a third predefined algorithm to determine a third subset of the numbers in the non-random, repeatable patient identifier. In an example implementation, processing module 1402 processes the third subset of the responses in accordance with the third predefined algorithm to determine the third subset of the numbers.

At step 1208, a fourth subset of the responses is processed in accordance with a fourth predefined algorithm to determine a fourth subset of the numbers in the non-random, repeatable patient identifier. In an example implementation, processing module 1402 processes the fourth subset of the response in accordance with the fourth predefined algorithm to determine the fourth subset of the numbers.

In some example embodiments, one or more steps 1202, 1204, 1206, and/or 1208 of flowchart 1200 may not be performed. Moreover, steps in addition to or in lieu of steps 1202, 1204, 1206, and/or 1208 may be performed.

As shown in FIG. 13, the method of flowchart 1300 begins at step 1302. In step 1302, a first logical operation is performed with respect to a first subset of numbers in a non-random, repeatable patient identifier that identifies a patient to provide a first integer value. In an example implementation, operation module 1404 performs the first logical operation with respect to the first subset of the numbers to provide the first integer value.

In an example embodiment, presume that the first subset of the numbers is referred to as “BlockA”. In accordance with this embodiment, step 1302 may be implemented in accordance with the following software code:

ChecksumA=MOD(((VALUE(MID(BlockA, 1, 1)) +VALUE(MID(BlockA, 3, 1)+VALUE(MID(BlockA, 5, 1))))*3)+(VALUE(MID(BlockA, 2, 1))+VALUE(MID(BlockA, 4, 1))), 10)

At step 1304, a second logical operation with respect to a second subset of the numbers in the non-random, repeatable patient identifier to provide a second integer value. In an example implementation, operation module 1404 performs the second logical operation with respect to the second subset of the numbers to provide the second integer value.

In an example embodiment, presume that the second subset of the numbers is referred to as “BlockB”. In accordance with this embodiment, step 1304 may be implemented in accordance with the following software code:

ChecksumB=MOD(((VALUE(MID(BlockB, 1, 1))+VALUE(MID(BlockB, 3, 1)+VALUE(MID(BlockB, 5, 1))))*3)+(VALUE(MID(BlockB, 2, 1))+VALUE(MID(BlockB, 4, 1))), 10)

At step 1306, a third logical operation is performed with respect to a third subset of the numbers in the non-random, repeatable patient identifier to provide a third integer value. In an example implementation, operation module 1404 performs the third logical operation with respect to the third subset of the numbers to provide the third integer value.

In an example embodiment, presume that the third subset of the numbers is referred to as “BlockC”. In accordance with this embodiment, step 1306 may be implemented in accordance with the following software code:

ChecksumC=MOD(((VALUE(MID(BlockC, 1, 1))+VALUE(MID(BlockC, 3, 1)+VALUE(MID(BlockC, 5, 1))))*3)+(VALUE(MID(BlockC, 2, 1))+VALUE(MID(BlockC, 4, 1))), 10)

At step 1308, a fourth logical operation is performed with respect to a fourth subset of the numbers in the non-random, repeatable patient identifier to provide a fourth integer value. In an example implementation, operation module 1404 performs the fourth logical operation with respect to the fourth subset of the numbers to provide the fourth integer value.

In an example embodiment, presume that the fourth subset of the numbers is referred to as “BlockD”. In accordance with this embodiment, step 1308 may be implemented in accordance with the following software code:

ChecksumD=MOD(((VALUE(MID(BlockD, 1, 1))+VALUE(MID(BlockD, 3, 1)+VALUE(MID(BlockD, 5, 1))))*3)+(VALUE(MID(BlockD, 2, 1))+VALUE(MID(BlockD, 4, 1))), 10)

At step 1310, the first integer value, the second integer value, the third integer value, and the fourth integer value are concatenated to provide a checksum identifier to facilitate detection of an error with respect to reproduction of the non-random, repeatable patient identifier. In an example implementation, concatenation module 1406 concatenates the first, second, third, and fourth integer values to provide the checksum identifier.

In an example embodiment, step 1310 may be implemented in accordance with the following software code:

Checksum=Text(ChecksumA, “0”)&text(ChecksumB,“0”) & text(ChecksumC, “0”) & text(ChecksumD, “0”)

In some example embodiments, one or more steps 1302, 1304, 1306, 1308, and/or 1310 of flowchart 1300 may not be performed. Moreover, steps in addition to or in lieu of steps 1302, 1304, 1306, 1308, and/or 1310 may be performed.

It will be recognized that patient ID server system 1400 may not include one or more of processing module 1402, operation module 1404, and/or concatenation module 1406. Furthermore, patient ID server system 1400 may include modules in addition to or in lieu of processing module 1402, operation module 1404, and/or concatenation module 1406.

String determination module 302, string concatenation module 304, checksum module 306, association module 308, determination module 502, operation module 504, character concatenation module 506, string determination module 1002, checksum module 1004, character concatenation module 1006, capitalization module 1008, operation module 1010, combination module 1012, processing module 1402, operation module 1404, and concatenation module 1406 may be implemented in hardware, software, firmware, or any combination thereof

For example, string determination module 302, string concatenation module 304, checksum module 306, association module 308, determination module 502, operation module 504, character concatenation module 506, string determination module 1002, checksum module 1004, character concatenation module 1006, capitalization module 1008, operation module 1010, combination module 1012, processing module 1402, operation module 1404, and/or concatenation module 1406 may be implemented as computer program code configured to be executed in one or more processors.

In another example, string determination module 302, string concatenation module 304, checksum module 306, association module 308, determination module 502, operation module 504, character concatenation module 506, string determination module 1002, checksum module 1004, character concatenation module 1006, capitalization module 1008, operation module 1010, combination module 1012, processing module 1402, operation module 1404, and/or concatenation module 1406 may be implemented as hardware logic/electrical circuitry.

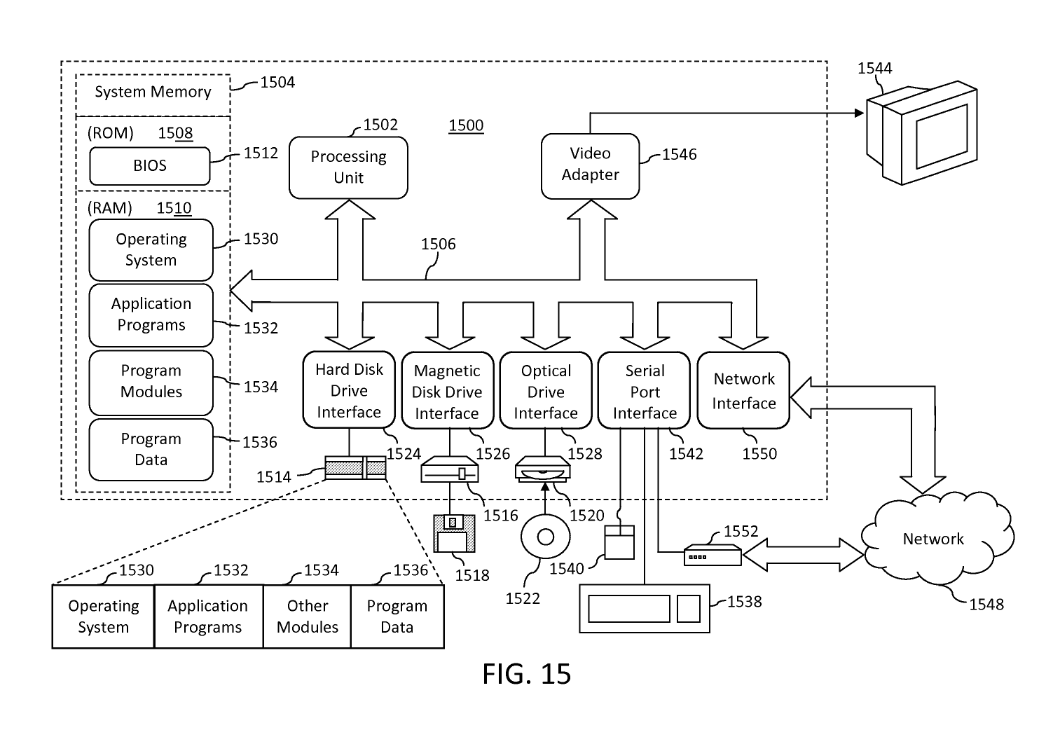

FIG. 15 depicts an example computer 1500 in which embodiments may be implemented. Any of user systems 102A-102M and patient ID server system 106 shown in FIG. 1 (or any one or more subcomponents thereof shown in FIGS. 3, 5, 10, and 14) may be implemented using computer 1500, including one or more features of computer 1500 and/or alternative features. Computer 1500 may be a general-purpose computing device in the form of a conventional personal computer, a mobile computer, or a workstation, for example, or computer 1500 may be a special purpose computing device. The description of computer 1500 provided herein is provided for purposes of illustration, and is not intended to be limiting. Embodiments may be implemented in further types of computer systems, as would be known to persons skilled in the relevant art(s).

As shown in FIG. 15, computer 1500 includes a processing unit 1502, a system memory 1504, and a bus 1506 that couples various system components including system memory 1504 to processing unit 1502. Bus 1506 represents one or more of any of several types of bus structures, including a memory bus or memory controller, a peripheral bus, an accelerated graphics port, and a processor or local bus using any of a variety of bus architectures. System memory 1504 includes read only memory (ROM) 1508 and random access memory (RAM) 1510. A basic input/output system 1512 (BIOS) is stored in ROM 1508.

Computer 1500 also has one or more of the following drives: a hard disk drive 1514 for reading from and writing to a hard disk, a magnetic disk drive 1516 for reading from or writing to a removable magnetic disk 1518, and an optical disk drive 1520 for reading from or writing to a removable optical disk 1522 such as a CD ROM, DVD ROM, or other optical media. Hard disk drive 1514, magnetic disk drive 1516, and optical disk drive 1520 are connected to bus 1506 by a hard disk drive interface 1524, a magnetic disk drive interface 1526, and an optical drive interface 1528, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1530, one or more application programs 1532, other program modules 1534, and program data 1536. Application programs 1532 or program modules 1534 may include, for example, computer program logic for implementing string determination module 302, string concatenation module 304, checksum module 306, association module 308, determination module 502, operation module 504, character concatenation module 506, string determination module 1002, checksum module 1004, character concatenation module 1006, capitalization module 1008, operation module 1010, combination module 1012, processing module 1402, operation module 1404, concatenation module 1406, flowchart 200 (including any step of flowchart 200), flowchart 400 (including any step of flowchart 400), flowchart 600 (including any step of flowchart 600), flowchart 700 (including any step of flowchart 700), flowchart 800 (including any step of flowchart 800), flowchart 900 (including any step of flowchart 900), flowchart 1100 (including any step of flowchart 1100), flowchart 1200 (including any step of flowchart 1200), and/or flowchart 1300 (including any step of flowchart 1300), as described herein.

A user may enter commands and information into the computer 1500 through input devices such as keyboard 1538 and pointing device 1540. Other input devices (not shown) may include a microphone, joystick, game pad, satellite dish, scanner, or the like. These and other input devices are often connected to the processing unit 1502 through a serial port interface 1542 that is coupled to bus 1506, but may be connected by other interfaces, such as a parallel port, game port, or a universal serial bus (USB).

A display device 1544 (e.g., a monitor) is also connected to bus 1506 via an interface, such as a video adapter 1546. In addition to display device 1544, computer 1500 may include other peripheral output devices (not shown) such as speakers and printers.

Computer 1500 is connected to a network 1548 (e.g., the Internet) through a network interface or adapter 1550, a modem 1552, or other means for establishing communications over the network. Modem 1552, which may be internal or external, is connected to bus 1506 via serial port interface 1542.

As used herein, the terms “computer program medium” and “computer-readable medium” are used to generally refer to media such as the hard disk associated with hard disk drive 1514, removable magnetic disk 1518, removable optical disk 1522, as well as other media such as flash memory cards, digital video disks, random access memories (RAMs), read only memories (ROMs), and the like. Such computer-readable storage media are distinguished from and non-overlapping with communication media. Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Example embodiments are also directed to such communication media.

As noted above, computer programs and modules (including application programs 1532 and other program modules 1534) may be stored on the hard disk, magnetic disk, optical disk, ROM, or RAM. Such computer programs may also be received via network interface 1550 or serial port interface 1542. Such computer programs, when executed or loaded by an application, enable computer 1500 to implement features of embodiments discussed herein. Accordingly, such computer programs represent controllers of the computer 1500.

Example embodiments are also directed to computer program products comprising software (e.g., computer-readable instructions) stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

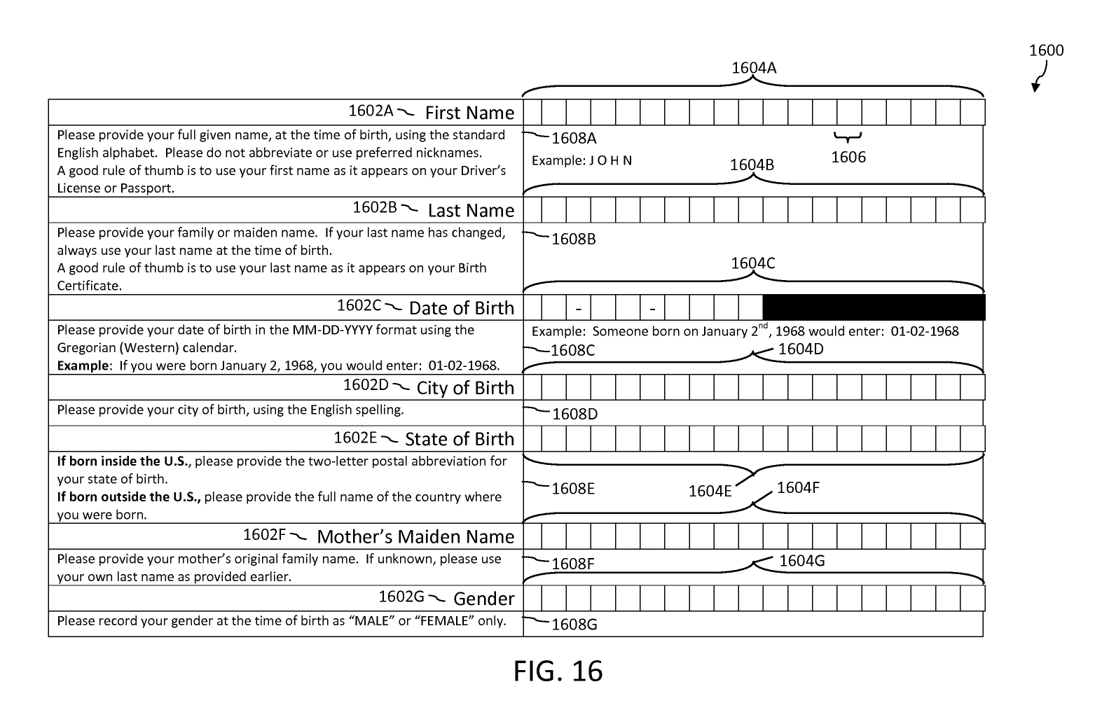

FIG. 16 depicts an example questionnaire 1600 that includes a plurality of inquiries 102A-102G regarding immutable characteristics of a patient in accordance with an embodiment. Questionnaire 1600 is shown to include a first inquiry 1602A that requests a first name of the patient, a second inquiry 1602B that requests a last name of the patient, a third inquiry 1602C that requests a date of birth of the patient, a fourth inquiry 1602D that requests a city of birth of the patient, a fifth inquiry 1602E that requests a state of birth of the patient, a sixth inquiry 1602F that requests a maiden name of the mother of the patient, and a seventh inquiry 1602G that requests a gender of the patient. Questionnaire 1600 is shown to include seven inquiries for illustrative purposes and is not intended to be limiting. Moreover, the example immutable characteristics with which the inquiries 1602A-1602G pertain are provided for illustrative purposes and are not intended to be limiting. It will be recognized that questionnaire 1600 may include any suitable number of inquiries regarding any suitable immutable characteristics of the patient.

A patient identifier that identifies the patient may be generated based on responses that the patient provides to the inquiries 1602A-1602G in questionnaire 1600. As shown in FIG. 16, the inquiries 1602A-1602G correspond to respective response fields 1604A-1604G in which the patient may enter responses regarding the respective inquiries 1602A-1602G. Each of the response fields 1604A-1604G includes a plurality of character fields 1606. Each character field is configured to include a single character of the corresponding response. The inquiries 1602A-1602G are shown to be associated with respective instructions 1608A-1608G regarding entry of the immutable characteristics of the patient in the response fields 1604A-1604G for illustrative purposes, though the scope of the embodiments is not limited in this respect.

The inquiries 1602A-1602G may be provided to the patient in a list, as shown in questionnaire 1600, one-by-one, two or more at a time, or in any other suitable manner.

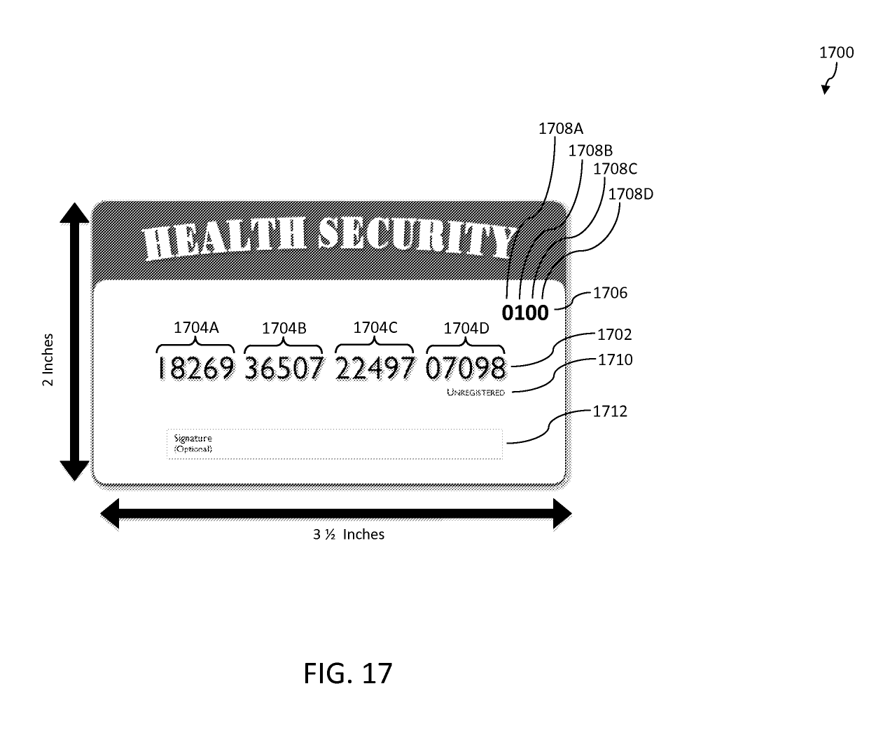

FIG. 17 depicts an example health security card 1700 that includes a patient identifier 1702 in accordance with an embodiment. Patient identifier 1702 includes a plurality of characters. The plurality of characters includes a first subset 1704A, a second subset 1704B, a third subset 1704C, and a fourth subset 1704D of the characters. For instance, each of the subsets 1704A, 1704B, 1704C, and 1704D may be based on a respective subset of responses regarding immutable characteristics of the patient. Patient identifier 1702 is shown in FIG. 17 to include twenty characters, and each of subsets 1704A, 1704B, 1704C, and 1704D is shown to include five characters, for illustrative purposes and are not intended to be limiting. It will be recognized that patient identifier 1702 and each of subsets 1704A, 1704B, 1704C, and 1704D may include any suitable number of characters. Moreover, patient identifier 1702 may includes any suitable number of subsets.

Health security card 1700 further includes a checksum identifier 1706 that is generated based on patient identifier 1702. Checksum identifier 1706 includes a first character 1708A, a second character 1708B, a third character 1708C, and a fourth character 1708D. In accordance with some example embodiments, first character 1708A is generated based on first subset 1704A of patient identifier 1702; second character 1708B is generated based on second subset 1704B of patient identifier 1702; third character 1708C is generated based on third subset 1704C of patient identifier 1702; and fourth character 1708D is generated based on fourth subset 1704D of patient identifier 1702.

Health security card 1700 also includes a registration indicator 1710 and signature field 1712. Registration indicator 1710 specifies whether the patient is a registered user of a system that correlates patient identifier 1702 with health records of the patient. For instance, registration indicator 1710 indicates that the patient who is associated with patient identifier 1702 is not a registered user of the system. Signature field 1712 is configured to include a signature of the patient. For instance, signature field 1712 may be provided using a textured material to facilitate signing of health security card 1700 by the patient. Health security card 1700 is shown to have a height of two inches and a length of three-and-a-half inches for illustrative purposes and is not intended to be limiting. Health security card 1700 may have any suitable dimensions.

### III. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described example embodiments, but should be defined only in accordance with the following claims and their equivalents.

What is claimed is:

1. A method comprising:
receiving a plurality of responses that specify a plurality of immutable characteristics of a patient in response to a plurality of inquiries regarding the plurality of immutable characteristics of the patient;
determining a plurality of character strings, each character string being based on a respective subset of the plurality of responses; and
concatenating the plurality of character strings to provide a patient identifier that identifies the patient.

2. The method of claim 1, wherein determining the plurality of character strings comprises:
determining the plurality of character strings to include a first character string, a second character string, a third character string, and a fourth character string,
the first character string being based on at least a first name of the patient,
the second character string being based on at least a last name of the patient,
the third character string being based on at least a birth date of the patient, and
the fourth character string being based on at least a geographic region that is associated with the patient.

3. The method of claim 2, wherein the second character string is further based on a birth city of the patient.

4. The method of claim 2, wherein the geographic region is at least one of a birth state or a birth country of the patient; and
wherein the fourth character string is further based on a maiden name of a mother of the patient and a gender of the patient.

5. The method of claim 1, wherein receiving the plurality of responses comprises:
receiving a first response that specifies a first name of the patient in response to a first inquiry regarding the first name of the patient;
wherein determining the plurality of character strings comprises:
if the first response includes fewer than three characters, concatenating one or more characters to the first response to cause the first response to include three characters;
capitalizing one or more designated characters of the first response;
performing a logical operation with respect to the first response to provide a specified character string of the plurality of character strings, each character of the specified character string being a number; and
if a least significant character of the specified character string is an odd number, adding a designated number to the specified character string; and
wherein concatenating the plurality of character strings comprises:
concatenating the plurality of character strings such that the specified character string is arranged to be a first character string in the plurality of character strings.

6. The method of claim 1, wherein receiving the plurality of responses comprises:
receiving a first response that specifies a last name of the patient in response to a first inquiry regarding the last name of the patient; and
receiving a second response that specifies a birth city of the patient in response to a second inquiry regarding the birth city of the patient;
wherein determining the plurality of character strings comprises:
if the first response includes fewer than three characters, concatenating one or more characters to the first response to cause the first response to include three characters;
capitalizing one or more designated characters of the first response;
performing a first logical operation with respect to the first response to provide a first intermediate character string, each character of the first intermediate character string being a number;
if the second response includes fewer than three characters, concatenating one or more characters to the second response to cause the second response to include three characters;
capitalizing one or more designated characters of the second response;
performing a second logical operation with respect to the second response to provide a second intermediate character string, each character of the second intermediate character string being a number;
if a least significant character of the second intermediate character string is an odd number, adding a designated number to the second intermediate character string; and
combining the first intermediate character string and the second intermediate character string to provide a combined character string; and
wherein concatenating the plurality of character strings comprises:
concatenating the plurality of character strings such that the combined character string is arranged to be a second character string in the plurality of character strings.

7. The method of claim 1, wherein receiving the plurality of responses comprises:
receiving a first response that specifies a birth date of the patient in response to a first inquiry regarding the birth date of the patient;
wherein determining the plurality of character strings comprises:
performing a logical operation with respect to the first response to provide a designated character string of the plurality of character strings, each character of the designated character string being a number; and
wherein concatenating the plurality of character strings comprises:
concatenating the plurality of character strings such that the designated character string is arranged to be a third character string in the plurality of character strings.

8. The method of claim 1, wherein receiving the plurality of responses comprises:
receiving a first response that specifies a geographic region that is associated with the patient in response to a first inquiry regarding the geographic region, the geographic region being a birth state or a birth country of the patient; and
receiving a second response that specifies a maiden name of a mother of the patient in response to a second inquiry regarding the maiden name of the mother of the patient;
receiving a third response that specifies a gender of the patient in response to a third inquiry regarding the gender of the patient;
wherein determining the plurality of character strings comprises:
if the first response includes fewer than three characters, concatenating one or more characters to the first response to cause the first response to include three characters;
capitalizing one or more designated characters of the first response;
performing a first logical operation with respect to the first response to provide a first intermediate character string, each character of the first intermediate character string being a number;
if the third response indicates that the gender of the patient is female, adding a designated number to the first intermediate character string;
if the second response includes fewer than three characters, concatenating one or more characters to the second response to cause the second response to include three characters;
capitalizing one or more designated characters of the second response;
performing a second logical operation with respect to the second response to provide a second intermediate character string, each character of the second intermediate character string being a number; and
combining the first intermediate character string and the second intermediate character string to provide a resultant character string; and
wherein concatenating the plurality of character strings comprises:
concatenating the plurality of character strings such that the resultant character string is arranged to be a fourth character string in the plurality of character strings.

9. The method of claim 1, further comprising:
performing a logical operation with respect to the plurality of character strings to determine a multi-character checksum identifier that includes fewer characters than the patient identifier; and
associating the multi-character checksum identifier with the patient identifier to facilitate detection of an error with respect to reproduction of the patient identifier.

10. The method of claim 9, wherein concatenating the plurality of character strings comprises:
concatenating a first character string, a second character string, a third character string, and a fourth character string, in consecutive order, to provide the patient identifier; and
wherein performing the logical operation with respect to the plurality of character strings comprises:
performing a first logical operation with respect to characters in the first character string to provide a first integer value;
performing a second logical operation with respect to characters in the second character string to provide a second integer value;
performing a third logical operation with respect to characters in the third character string to provide a third integer value;
performing a fourth logical operation with respect to characters in the fourth character string to provide a fourth integer value; and
concatenating the first integer value, the second integer value, the third integer value, and the fourth integer value, in consecutive order, to provide the multi-character checksum identifier.

11. A method comprising:
receiving a plurality of responses that specify a plurality of immutable characteristics of a patient in response to a plurality of inquiries regarding the plurality of immutable characteristics of the patient; and
processing subsets of the plurality of responses in accordance with respective predefined algorithms to determine a non-random, repeatable patient identifier that identifies the patient.

12. The method of claim 11, wherein the non-random, repeatable patient identifier includes a plurality of numbers; and
wherein processing the subsets of the plurality of responses comprises:
processing a first subset of the plurality of responses in accordance with a first predefined algorithm to determine a first subset of the plurality of numbers in the non-random, repeatable patient identifier;
processing a second subset of the plurality of responses in accordance with a second predefined algorithm to determine a second subset of the plurality of numbers in the non-random, repeatable patient identifier;
processing a third subset of the plurality of responses in accordance with a third predefined algorithm to determine a third subset of the plurality of numbers in the non-random, repeatable patient identifier; and
processing a fourth subset of the plurality of responses in accordance with a fourth predefined algorithm to determine a fourth subset of the plurality of numbers in the non-random, repeatable patient identifier.

13. The method of claim 12, wherein processing the first subset of the plurality of responses comprises:
processing a first response, which specifies a first name of the patient, in accordance with the first predefined algorithm to determine the first subset of the plurality of numbers;
wherein processing the second subset of the plurality of responses comprises:
processing a second response, which specifies a last name of the patient, and a third response, which specifies a birth city of the patient, in accordance with the second predefined algorithm to determine the second subset of the plurality of numbers;
wherein processing the third subset of the plurality of responses comprises:
processing a fourth response, which specifies a birth date of the patient, in accordance with the third predefined algorithm to determine the third subset of the plurality of numbers;
wherein processing the fourth subset of the plurality of responses comprises:
processing a fifth response, which specifies a birth state or a birth country of the patient, a sixth response, which specifies a maiden name of a mother of the patient, and a seventh response, which specifies a gender of the patient, in accordance with the fourth predefined algorithm to determine the fourth subset of the plurality of numbers; and
wherein processing the subsets of the plurality of responses further comprises:
concatenating the first subset of the plurality of numbers, the second subset of the plurality of numbers, the third subset of the plurality of numbers, and the fourth subset of the plurality of numbers, in consecutive order, to provide the non-random, repeatable patient identifier.

14. The method of claim 12, further comprising:
performing a first logical operation with respect to the first subset of the plurality of numbers to provide a first integer value;
performing a second logical operation with respect to the second subset of the plurality of numbers to provide a second integer value;
performing a third logical operation with respect to the third subset of the plurality of numbers to provide a third integer value;
performing a fourth logical operation with respect to the fourth subset of the plurality of numbers to provide a fourth integer value; and
concatenating the first integer value, the second integer value, the third integer value, and the fourth integer value to provide a checksum identifier to facilitate detection of an error with respect to reproduction of the non-random, repeatable patient identifier.

15. A system comprising:
a string determination module configured to determine a plurality of character strings, each character string being based on a respective subset of a plurality of responses to a plurality of respective queries regarding a plurality of respective immutable characteristics of a patient, the plurality of responses specifying the plurality of respective immutable characteristics of the patient; and
a string concatenation module configured to concatenate the plurality of character strings to provide a patient identifier that identifies the patient.

16. The system of claim 15, wherein the string determination module comprises:
a character concatenation module configured to concatenate one or more characters to a first response of the plurality of responses that specifies a first name of the patient if the first response includes fewer than three characters to cause the first response to include three characters;
a capitalization module configured to capitalize one or more designated characters of the first response; and
an operation module configured to perform a logical operation with respect to the first response to provide a specified character string of the plurality of character strings, each character of the specified character string being a number,
the operation module further configured to add a designated number to the specified character string if a least significant character of the specified character string is an odd number; and
wherein the string concatenation module is configured to concatenate the plurality of character strings such that the specified character string is arranged to be a first character string in the plurality of character strings.

17. The system of claim 15, wherein the string determination module comprises:
a character concatenation module configured to concatenate one or more characters to a first response of the plurality of responses that specifies a last name of the patient if the first response includes fewer than three characters to cause the first response to include three characters,
the character concatenation module further configured to concatenate one or more characters to a second response that specifies a birth city of the patient if the second response includes fewer than three characters to cause the second response to include three characters;
a capitalization module configured to capitalize one or more first designated characters of the first response, the capitalization module further configured to capitalize one or more second designated characters of the second response;
an operation module configured to perform a first logical operation with respect to the first response to provide a first intermediate character string, each character of the first intermediate character string being a number,
the operation module further configured to perform a second logical operation with respect to the second response to provide a second intermediate character string, each character of the second intermediate character string being a number,
the operation module further configured to add a designated number to the second intermediate character string if a least significant character of the second intermediate character string is an odd number; and
a combination module configured to combine the first intermediate character string and the second intermediate character string to provide a combined character string; and
wherein the string concatenation module is configured to concatenate the plurality of character strings such that the combined character string is arranged to be a second character string in the plurality of character strings.

18. The system of claim 15, wherein the string determination module comprises:
an operation module configured to perform a logical operation with respect to a first response that specifies a birth date of the patient to provide a designated character string of the plurality of character strings, each character of the designated character string being a number; and
wherein the string concatenation module is configured to concatenate the plurality of character strings such that the designated character string is arranged to be a third character string in the plurality of character strings.

19. The system of claim 15, wherein the string determination module comprises:
a character concatenation module configured to concatenate one or more characters to a first response that specifies a birth state or a birth country of the patient if the first response includes fewer than three characters to cause the first response to include three characters,
the character concatenation module further configured to concatenate one or more characters to a second response that specifies a maiden name of a mother of the patient if the second response includes fewer than three characters to cause the second response to include three characters;
a capitalization module configured to capitalize one or more designated characters of the first response, the capitalization module further configured to capitalize one or more designated characters of the second response;
an operation module configured to perform a first logical operation with respect to the first response to provide a first intermediate character string, each character of the first intermediate character string being a number,
the operation module further configured to add a designated number to the first intermediate character string if a third response specifies that a gender of the patient is female,
the operation module further configured to perform a second logical operation with respect to the second response to provide a second intermediate character string, each character of the second intermediate character string being a number; and
a combination module configured to combine the first intermediate character string and the second intermediate character string to provide a resultant character string; and
wherein the string concatenation module is configured to concatenate the plurality of character strings such that the resultant character string is arranged to be a fourth character string in the plurality of character strings.

20. The system of claim 15, wherein the string concatenation module is configured to concatenate a first character string, a second character string, a third character string, and a fourth character string, in consecutive order, to provide the patient identifier; and
wherein the system further comprises:
an operation module configured to perform a first logical operation with respect to characters in the first character string to provide a first integer value,
the operation module further configured to perform a second logical operation with respect to characters in the second character string to provide a second integer value,
the operation module further configured to perform a third logical operation with respect to characters in the third character string to provide a third integer value,
the operation module further configured to perform a fourth logical operation with respect to characters in the fourth character string to provide a fourth integer value; and
a character concatenation module configured to concatenate the first integer value, the second integer value, the third integer value, and the fourth integer value, in consecutive order, to provide a checksum identifier to facilitate detection of an error with respect to reproduction of the patient identifier.
